(19) United States
(12) Patent Application Publication
(10) Pub. No.: US 2017/0230232 A1
(43) Pub. Date: Aug. 10, 2017

(54) SON for Dual Connectivity

(71) Applicant: Nokia Solutions and Networks Oy, Espoo (FI)

(72) Inventors: Yang LIU, Beijing (CN); Tsunehiko CHIBA, Saitama (JP); Yan Ji ZHANG, Beijing (CN)

(21) Appl. No.: 15/502,047

(22) PCT Filed: Aug. 7, 2014
(86) PCT No.: PCT/CN2014/083870

§ 371 Date: Feb. 6, 2017

(51) Int. Cl. H04L 12/24; H04W 24/10

(52) U.S. Cl. CPC H04L 41/0668; H04L 41/0681; H04L 41/0631; H04W 24/10; H04W 84/18

(57) ABSTRACT

It is provided a method, including detecting an occurrence of a link failure of a link to a secondary cell, wherein, before the occurrence of the link failure, an apparatus performing the method is connected in dual connectivity to the secondary cell via the link and to a master cell different from the secondary cell; informing the master cell on the link failure by a report if the occurrence of the link failure is detected.

### FIELD OF THE INVENTION

The present invention relates to an apparatus, a method, and a computer program product related to dual connectivity. More particularly, the present invention relates to an apparatus, a method, and a computer program product related to a self-optimizing network with dual connectivity.

### BACKGROUND OF THE INVENTION

### ABBREVIATIONS

3GPP Third Generation Partnership Project
DC Dual Connectivity
ECGI E-UTRAN Cell Global Identifier
eNB evolved NodeB
GPRS General Packet Radio Service
HO HandOver
MeNB Master eNB
PCI Physical Cell Identifier
PCell Primary cell
PSCell Primary SCell
PUCCH Physical Uplink Control Channel
RAN Radio Access Network
Rel Release
RLF Radio Link Failure
RRC Radio Resource Control
RSRP Reference Signal Received Power
RSRQ Reference Signal Received Quality
SCell Secondary Cell
SCG Secondary Cell Group
SeNB Secondary eNB
SI Study Item
SON Self-Optimizing Network
S-RLF Secondary eNB RLF
TR Technical Report
TS Technical Specification
TTT Time to Trigger
UE User Equipment
UL Uplink
UMTS Universal Mobile Telecommunications System
WI Work Item
Wi-Fi Wireless Fidelity
X2 Interface between base stations (eNodeBs)
X2AP X2 Application Part

Rel-12 Small Cell Enhancement Higher Layer SI followed by Dual Connectivity WI RP-132069 is ongoing in RAN2 and RAN3. TR36.842 captures the outcome of the SI, and dual connectivity is becoming a main stream in Rel-12 discussion. In dual connectivity, UE is simultaneously connected with MeNB and SeNB, and control plane (RRC) for both MeNB and SeNB will be located in MeNB. There is one PCell associated to MeNB, and there is one PSCell associated to the SeNB and there may be a group of SCells in SeNB. PSCell carries PUCCH, while other SCells do not carry PUCCH. MeNB may have one or more SCells, too, in addition to PCell. The RRC control plane for the UE is located in MeNB and not in SeNB. In particular, MeNB acts as mobility anchor towards the core network. MeNB is changed only at handover, while SeNB may be added or released depending on the needs as determined by MeNB. SeNB provides additional radio resources to the UE. In Rel-12, there is only one SeNB per MeNB allowed.

MeNB is sometimes used synonymously with PCell, if not otherwise indicated or made clear from the context.

Now RAN2/3 has started to work on detailed signaling procedures to support dual connectivity operations on SCG addition/release etc., however some of these procedures are still not clear and need to be solved.

In legacy SON solutions, in case of RLF, after losing the connection with the source cell, UE will report this event to network side when UE gets connected to a new cell next time, and this new cell will deliver X2AP message RLF INDICATION (including the RLF information) to the source cell (i.e. the cell where RLF happens), based on the information provided by UE. This RLF information will help the source cell to optimize the mobility parameters e.g. TTT, A3 offset, mobility thresholds, . . . , etc.

SON is described in 3GPP TS 36.902, Self-configuring and self-optimizing network (SON) use cases and solutions, and the RLF indication is described in 3GPP TS 36.423, X2AP RLF INDICATION (see FIG. 1).

### SUMMARY OF THE INVENTION

It is an object of the present invention to improve the prior art.

According to a first aspect of the invention, there is provided an apparatus, comprising failure detecting means adapted to detect an occurrence of a link failure of a link to a secondary cell, wherein, before the occurrence of the link failure, the apparatus is connected in dual connectivity to the secondary cell via the link and to a master cell different from the secondary cell; informing means adapted to inform the master cell on the link failure by a report if the occurrence of the link failure is detected.

The apparatus may further comprise control exchanging means adapted to exchange with the master cell a control message of a radio resource control related to the link.

The report may comprise at least one of a result of a first power measurement and a result of a first quality measurement for the secondary cell.

The apparatus may further comprise monitoring means adapted to monitor if the link failure is caused because a number of radio link control retransmissions by the apparatus exceeds a maximum number; secondary cell detecting means adapted to detect at least one further secondary cell different from the secondary cell and the master cell, wherein the apparatus is additionally connected to the further secondary cell; wherein the report generating means may be adapted to generate the report such that the report additionally comprises at least one of a result of a second power measurement and result of a second quality measurement for the further secondary cell if the link failure is caused because the maximum number of radio link control retransmissions and the apparatus is connected to the further secondary cell.

The report may comprise a reason for the link failure.

According to a second aspect of the invention, there is provided an apparatus, comprising failure detecting circuit configured to detect an occurrence of a link failure of a link to a secondary cell, wherein, before the occurrence of the link failure, the apparatus is connected in dual connectivity to the secondary cell via the link and to a master cell different from the secondary cell; informing circuit configured to inform the master cell on the link failure by a report if the occurrence of the link failure is detected.

The apparatus may further comprise control exchanging circuit configured to exchange with the master cell a control message of a radio resource control related to the link.

The report may comprise at least one of a result of a first power measurement and a result of a first quality measurement for the secondary cell.

The apparatus may further comprise monitoring circuit configured to monitor if the link failure is caused because a number of radio link control retransmissions by the apparatus exceeds a maximum number; secondary cell detecting circuit configured to detect at least one further secondary cell different from the secondary cell and the master cell, wherein the apparatus is additionally connected to the further secondary cell; wherein the report generating circuit may be configured to generate the report such that the report additionally comprises at least one of a result of a second power measurement and result of a second quality measurement for the further secondary cell if the link failure is caused because the maximum number of radio link control retransmissions and the apparatus is connected to the further secondary cell.

The report may comprise a reason for the link failure.

According to a third aspect of the invention, there is provided an apparatus, comprising monitoring means adapted to monitor if a report from a terminal is received, wherein the report reports on a link failure of a link of the terminal to a secondary cell; informing means adapted to inform, if the report is received, the secondary cell in a message on a presence of the report.

The message may comprise the report.

The message may not comprise the report, and the apparatus may further comprise providing means adapted to provide the report in response to an inquiry received from the secondary cell.

The message may comprise a request to the secondary cell. The request may request the secondary cell to release the link from the secondary cell to the terminal.

According to a fourth aspect of the invention, there is provided an apparatus, comprising monitoring circuit configured to monitor if a report from a terminal is received, wherein the report reports on a link failure of a link of the terminal to a secondary cell; informing circuit configured to inform, if the report is received, the secondary cell in a message on a presence of the report.

The message may comprise the report.

The message may not comprise the report, and the apparatus may further comprise providing circuit configured to provide the report in response to an inquiry received from the secondary cell.

The message may comprise a request to the secondary cell. The request may request the secondary cell to release the link from the secondary cell to the terminal.

According to a fifth aspect of the invention, there is provided an apparatus, comprising supervising means adapted to supervise if a message is received from a master base station, wherein the message comprises an indication of a presence of a report on a link failure of a link to a terminal; adapting means adapted to adapt, if the message is received, a radio parameter based on the report.

The radio parameter may comprise at least one of a time to trigger, an offset, and a mobility threshold.

The message may comprise the report.

The message may not comprise the report, and the apparatus may further comprise inquiring means adapted to inquire the report from the master cell; and receiving means adapted to receive the report in response to the inquiry.

The message may request the apparatus to release the link to the terminal.

According to a sixth aspect of the invention, there is provided an apparatus, comprising supervising circuit configured to supervise if a message is received from a master base station, wherein the message comprises an indication of a presence of a report on a link failure of a link to a terminal; adapting circuit configured to adapt, if the message is received, a radio parameter based on the report.

The radio parameter may comprise at least one of a time to trigger, an offset, and a mobility threshold.

The message may comprise the report.

The message may not comprise the report, and the apparatus may further comprise inquiring circuit configured to inquire the report from the master cell; and receiving circuit configured to receive the report in response to the inquiry.

The message may request the apparatus to release the link to the terminal.

According to a seventh aspect of the invention, there is provided a method, comprising detecting an occurrence of a link failure of a link to a secondary cell, wherein, before the occurrence of the link failure, an apparatus performing the method is connected in dual connectivity to the secondary cell via the link and to a master cell different from the secondary cell; informing the master cell on the link failure by a report if the occurrence of the link failure is detected.

The method may further comprise exchanging with the master cell a control message of a radio resource control related to the link.

The report may comprise at least one of a result of a first power measurement and a result of a first quality measurement for the secondary cell.

The method may further comprise monitoring if the link failure is caused because a number of radio link control retransmissions by the apparatus exceeds a maximum number; detecting at least one further secondary cell different from the secondary cell and the master cell, wherein the apparatus is additionally connected to the further secondary cell; wherein the report may be generated such that the report additionally comprises at least one of a result of a second power measurement and result of a second quality measurement for the further secondary cell if the link failure is caused because the maximum number of radio link control retransmissions and the apparatus is connected to the further secondary cell.

The report may comprise a reason for the link failure.

According to an eighth aspect of the invention, there is provided a method, comprising monitoring if a report from a terminal is received, wherein the report reports on a link failure of a link of the terminal to a secondary cell; informing, if the report is received, the secondary cell in a message on a presence of the report.

The message may comprise the report.

The message may not comprise the report, and the method may further comprise providing the report in response to an inquiry received from the secondary cell.

The message may comprise a request to the secondary cell. The request may request the secondary cell to release the link from the secondary cell to the terminal.

According to a ninth aspect of the invention, there is provided a method, comprising supervising if a message is received from a master base station, wherein the message comprises an indication of a presence of a report on a link failure of a link to a terminal; adapting, if the message is received, a radio parameter based on the report.

The radio parameter may comprise at least one of a time to trigger, an offset, and a mobility threshold.

The message may comprise the report.

The message may not comprise the report, and the method may further comprise inquiring the report from the master cell; and receiving the report in response to the inquiry.

The message may request an apparatus performing the method to release the link to the terminal.

Each of the methods of the seventh to ninth aspects may be a method of dual connectivity.

According to a tenth aspect of the invention, there is provided a computer program product comprising a set of instructions which, when executed on an apparatus, is configured to cause the apparatus to carry out the method according to any one of the seventh to ninth aspects. The computer program product may be embodied as a computer-readable medium or directly loadable into a computer.

According to some embodiments of the invention, at least one of the following advantages may be achieved:
Faster delivery of indication of S-RLF event to SeNB where S-RLF happened: UE does not need to wait to use RRCConnectrionSetupComplete message to indicate the availability of the failure report in next RRC connection setup procedure;
No need for dedicated RLF indication message on X2AP to deliver the S-RLF report from MeNB to SeNB. Instead the SeNB release request message may be used.
memory usage on UE is optimized because it does not need to store S-RLF report for a long time;
reliability of transmission of S-RLF reports from UE to the concerned SCell in SeNB is increased because UE failures and damages are less likely to occur before the S-RLF report is transmitted;
Dual connectivity UEs can better provide support to SON features such that the performance of dual connectivity may be improved; in particular:
SeNB receives S-RLF in nearly real-time such that the report can be better correlated to network conditions at the time of link failure.

It is to be understood that any of the above modifications can be applied singly or in combination to the respective aspects to which they refer, unless they are explicitly stated as excluding alternatives.

### BRIEF DESCRIPTION OF THE DRAWINGS

Further details, features, objects, and advantages are apparent from the following detailed description of the preferred embodiments of the present invention which is to be taken in conjunction with the appended drawings, wherein

FIG. 1 shows X2AP RLF INDICATION, taken from 3GPP TS 36.423;

FIG. 2 shows a S-RLF procedure according to an embodiment of the invention;

FIG. 3 shows an apparatus according to an embodiment of the invention;

FIG. 4 shows a method according to an embodiment of the invention;

FIG. 5 shows an apparatus according to an embodiment of the invention;

FIG. 6 shows a method according to an embodiment of the invention;

FIG. 7 shows an apparatus according to an embodiment of the invention;

FIG. 8 shows a method according to an embodiment of the invention; and

FIG. 9 shows an apparatus according to an embodiment of the invention.

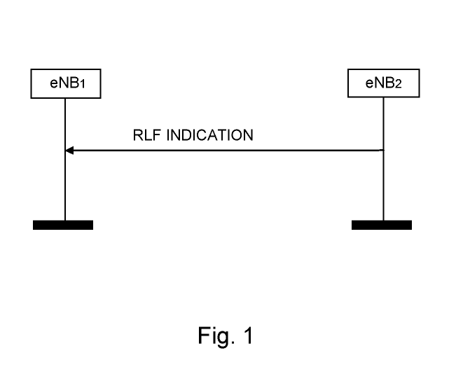

### DETAILED DESCRIPTION OF CERTAIN EMBODIMENTS

Herein below, certain embodiments of the present invention are described in detail with reference to the accompanying drawings, wherein the features of the embodiments can be freely combined with each other unless otherwise described.

However, it is to be expressly understood that the description of certain embodiments is given for by way of example only, and that it is by no way intended to be understood as limiting the invention to the disclosed details.

Moreover, it is to be understood that the apparatus is configured to perform the corresponding method, although in some cases only the apparatus or only the method are described.

Dual connectivity may have some impacts to other features defined in 3GPP, e.g. SON.

In dual connectivity, where UE is served by a SeNB, a radio link failure on an SCell such as a PSCell may occur, which is called S-RLF. This information could also be used to help for SON purposes. However, according to conventional SON solutions, UE will report this event (via a RRCConnectionSetupComplete message) to the network only when UE will try to access to the network next time. An X2AP message RLF INDICATION will be used to deliver the S-RLF information. Thus, there is some delay for the network to obtain the S-RLF information, and X2AP signalling overhead per UE is introduced, which will burden the eNB handlings.

Some embodiments of the invention provide an optimization of S-RLF handling in dual connectivity for the purposes of SON.

According to some embodiments of the invention, in case of S-RLF between UE and SeNB, UE creates the S-RLF report and informs MeNB on the event by an indication. The report will be provided from UE to MeNB together with the indication, or the report is the indication of S-RLF.

The report may include a RSRP measurement report and/or a RSRQ measurement report of the cell where S-RLF happens. The report may comprise the reason for the S-RLF.

According to some embodiments of the invention, MeNB will forward the S-RLF report to the SeNB for which the S-RLF occurred. MeNB may send the report to SeNB via e.g. SeNB release request message or via another message which is not dedicated for transmitting the report, and not via RLF INDICATION message.

Correspondingly to the message flow between UE and MeNB, there are several options for the message flow between MeNB and SeNB, depending on implementation according to embodiments of the invention: MeNB may provide the S-RLF report to SeNB when it indicates the occurrence of S-RLF to SeNB (in this case, the report may be the indication), MeNB my provide the report to SeNB after MeNB received the report from UE (if the indication from UE does not comprise the report), or MeNB may provide the report to SeNB upon receipt of an inquiry from SeNB.

According to some embodiments of the invention, SeNB utilizes the S-RLF report for SON purpose, e.g. to optimize the radio parameters to improve the quality of its radio network.

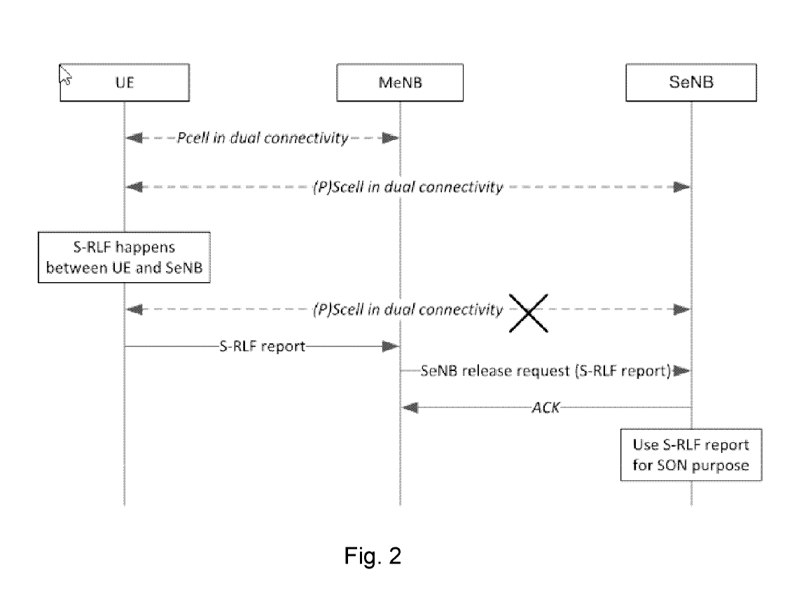

FIG. 2 shows a procedure according to an embodiment of the invention. As shown in FIG. 2, the UE is connected in DC with MeNB and a SeNB. The UE may be connected to more than one SeNB. However, the other SeNB are not shown and not relevant for the procedure.

Then, S-RLF happens between UE and SeNB. I.e., the radio link between UE and SeNB is disrupted such that UE is not connected to SeNB any more.

If S-RLF occurs between UE and SeNB, UE creates an S-RLF report to report on S-RLF. The S-RLF report may comprise additional information which may be useful for SeNB to optimize the network.

In some embodiments of the invention, S-RLF report comprises at least one of RSRP measurement results and RSRQ measurement results for the cell where S-RLF happens. In particular, in some embodiments of the invention:
if the S-RLF is triggered by reaching the maximum number of RLC retransmissions, RSRP/RSRQ measurement results of all SCells (including the SCell where S-RLF occurred and the PSCell) may be included in the report;
if the S-RLF is triggered by other reasons, only RSRP/RSRQ measurement result of the SCell where S-RLF occurred may be included in the report.

According to some embodiments of the invention, the report may comprise an indication of a reason for the failure (S-RLF).

According to some embodiments of the invention, UE may deliver this S-RLF report to MeNB via a new UL RRC message. Alternatively, the report may be transmitted to MeNB by a new information element in a conventional RRC message, which is adapted accordingly, such as measurement report, Uplink information transfer.

Upon receiving the S-RLF report from UE, MeNB is aware that SeNB suffered a radio link failure, and SeNB release procedure might be triggered accordingly.

According to some embodiments of the invention, MeNB may insert the S-RLF report into a message which is not dedicated to transmitting the S-RLF report or an indication of a presence of the S-RLF report. An example of such a message is the SeNB release request message sent from MeNB to SeNB. Alternatively, MeNB may provide the S-RLF indication and/or report to SeNB in a dedicated message such as RLF INDICATION. The former option has the advantage of minimizing the number of exchanged messages on X2 interface between MeNB and SeNB.

According to some embodiments of the invention, SeNB may use the S-RLF report for SON purposes, e.g. to optimize the radio parameters e.g. TTT, A3 offset, mobility thresholds, etc. In particular, SeNB may use the S-RLF report in order to avoid too early/late handovers caused by un-appropriate mobility parameter settings.

The S-RLF report may have any format suitable for the purpose. The format of the S-RLF report transmitted by the UE may be the same as or different from the format of the S-RLF report forwarded by MeNB. The S-RLF report forwarded by MeNB may comprise all the information or a subset of the information comprised in the S-RLF report transmitted by the UE.

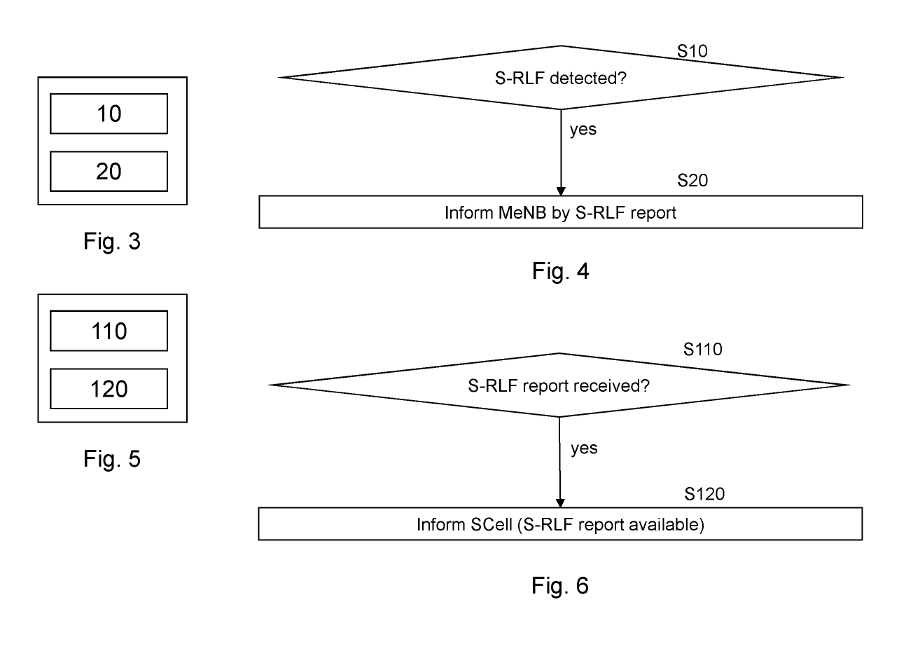

FIG. 3 shows an apparatus according to an embodiment of the invention. The apparatus may be a terminal such as a UE, or an element thereof. FIG. 4 shows a method according to an embodiment of the invention. The apparatus according to FIG. 3 may perform the method of FIG. 4 but is not limited to this method. The method of FIG. 4 may be performed by the apparatus of FIG. 3 but is not limited to being performed by this apparatus.

The apparatus comprises failure detecting means 10 and informing means 20.

The failure detecting means 10 detects an occurrence of a link failure of a link to a secondary cell (S10). Before the occurrence of the link failure, the apparatus was connected in dual connectivity to the secondary cell and to a master cell different from the secondary cell. The connection to the secondary cell was via the link. After the occurrence of the link failure, the apparatus is not connected any more to the secondary cell via the link. RRC messages are exchanged with the master cell but not with the secondary cell.

The informing means 20 informs the master cell on the link failure if the occurrence of the link failure is detected (S20). The information on the link failure comprises a report related to the link failure.

FIG. 5 shows an apparatus according to an embodiment of the invention. The apparatus may be a base station such as an eNodeB, in particular a MeNB, or an element thereof. FIG. 6 shows a method according to an embodiment of the invention. The apparatus according to FIG. 5 may perform the method of FIG. 6 but is not limited to this method. The method of FIG. 6 may be performed by the apparatus of FIG. 5 but is not limited to being performed by this apparatus.

The apparatus comprises monitoring means 110 and informing means 120.

The monitoring means 110 monitors if a report from a terminal is received (S110). The report reports on a link failure of a link of the terminal to a secondary cell. The terminal may be connected to the apparatus and to the secondary cell in dual connectivity, wherein the apparatus comprises the Master eNB.

If the report is received (S110=“yes”), the informing means 120 issues a message to the secondary cell (S120). By the message, the informing means informs the secondary cell on the presence of the report on the link failure at the apparatus. E.g., the message may be a request such as a request to the secondary cell to release the link. The message may or may not comprise the report on the link failure.

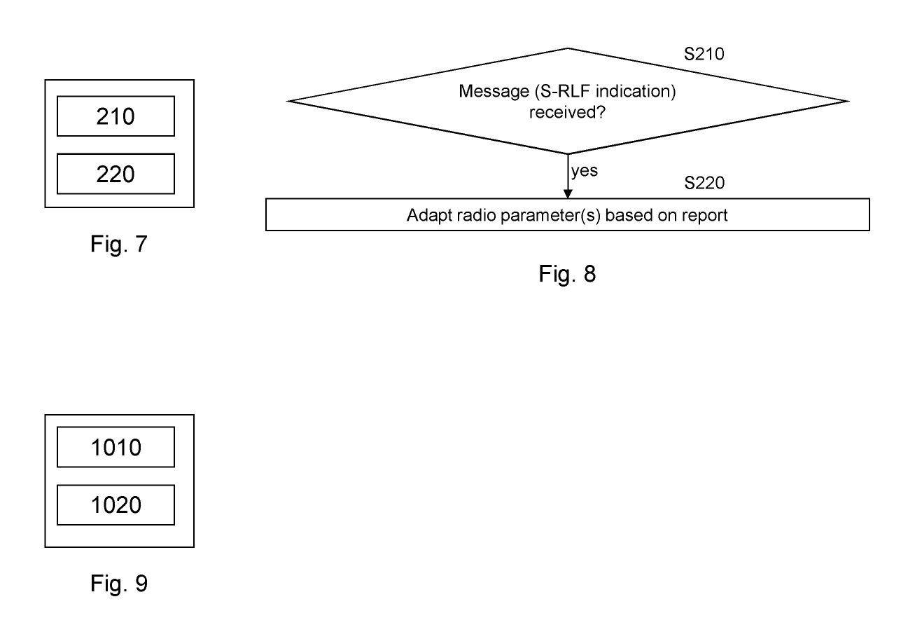

FIG. 7 shows an apparatus according to an embodiment of the invention. The apparatus may be a base station such as an eNodeB, in particular a SeNB, or an element thereof. FIG. 8 shows a method according to an embodiment of the invention. The apparatus according to FIG. 7 may perform the method of FIG. 8 but is not limited to this method. The method of FIG. 8 may be performed by the apparatus of FIG. 7 but is not limited to being performed by this apparatus.

The apparatus comprises supervising means 210 and adapting means 220.

The supervising means 210 supervises if a message is received (S210) from a master base station. The message comprises an indication of the presence of a report on a link failure of a link from the apparatus to a terminal. Before the link failure, the apparatus was connected to the terminal in dual connectivity with the master base station providing the primary cell. The message may comprise a request, whereby the apparatus is requested to release the link to the terminal.

The message may or may not comprise the report on the link failure.

If the message is received (S210=“yes”), the adapting means 220 adapts a radio parameter such as (but not limited to) a time to trigger, and/or an offset, and/or a mobility threshold, based on the report (S220). If the report is not comprised in the message, the apparatus may first request the report from the master base station and adapt the radio parameter after receipt of the report.

FIG. 9 shows an apparatus according to an embodiment of the invention. The apparatus comprises at least one processor 1010, at least one memory 1020 including computer program code, and the at least one processor, with the at least one memory and the computer program code, being arranged to cause the apparatus to at least perform at least one of the methods according to FIGS. 4, 6, and 8.

Embodiments of the invention are described where the S-RLF report is sent from the UE to the MeNB. However, according to some embodiments of the invention, if the UE is connected to more than one SeNB, UE may send the S-RLF report to another SeNB than the one where the S-RLF occurred. The other SeNB may forward the report directly to the SeNB where the S-RLF occurred, e.g. in a dedicated X2AP message such as RLF INDICATION.

Embodiments of the invention may be employed in a 3GPP network. They may be employed also in other mobile networks enabling connections by master cells and secondary cells such as CDMA, EDGE, UMTS, LTE, LTE-A, Wi-Fi networks, etc.

A terminal may be any device capable to be connected to the radio access network, such as a UE, a laptop, a tablet, a smartphone, a communicator, a machine, a robot, a wearable etc.

The terms “connected to” and “served by” may be considered to by synonymous unless otherwise stated in a specific context.

One piece of information may be transmitted in one or plural messages from one entity to another entity. Each of these messages may comprise further (different) pieces of information.

Names of network elements, protocols, and methods are based on current standards. In other versions or other technologies, the names of these network elements and/or protocols and/or methods may be different, as long as they provide a corresponding functionality. The functionality may be integral to one or few of the network elements or it may be shared or distributed among the network elements, or their cloud.

If not otherwise stated or otherwise made clear from the context, the statement that two entities are different means that they perform different functions. It does not necessarily mean that they are based on different hardware. That is, each of the entities described in the present description may be based on a different hardware, or some or all of the entities may be based on the same hardware. It does not necessarily mean that they are based on different software. That is, each of the entities described in the present description may be based on different software, or some or all of the entities may be based on the same software. It does not necessarily mean that they are based on different firmware.

That is, each of the entities described in the present description may be based on different firmware, or some or all of the entities may be based on the same firmware.

According to the above description, it should thus be apparent that exemplary embodiments of the present invention provide, for example a terminal such as a user equipment, or a component thereof, an apparatus embodying the same, a method for controlling and/or operating the same, and computer program(s) controlling and/or operating the same as well as mediums carrying such computer program(s) and forming computer program product(s). Furthermore, according to the above description, it should thus be apparent that exemplary embodiments of the present invention provide, for example a base station or a cell thereof, such as a master cell or a secondary cell, or a component thereof, an apparatus embodying the same, a method for controlling and/or operating the same, and computer program(s) controlling and/or operating the same as well as mediums carrying such computer program(s) and forming computer program product(s).

Implementations of any of the above described blocks, apparatuses, systems, techniques or methods include, as non limiting examples, implementations as hardware, software, firmware, special purpose circuits or logic, general purpose hardware or controller or other computing devices, or some combination thereof.

It is to be understood that what is described above is what is presently considered the preferred embodiments of the present invention. However, it should be noted that the description of the preferred embodiments is given by way of example only and that various modifications may be made without departing from the scope of the invention as defined by the appended claims.

1.-15. (canceled)

16. Method, comprising
detecting an occurrence of a link failure of a link to a secondary cell, wherein, before the occurrence of the link failure, an apparatus performing the method is connected in dual connectivity to the secondary cell via the link and to a master cell different from the secondary cell;
informing the master cell on the link failure by a report if the occurrence of the link failure is detected.

17. The method according to claim 16, further comprising
exchanging with the master cell a control message of a radio resource control related to the link.

18. The method according to claim 16, wherein the report comprises at least one of a result of a first power measurement and a result of a first quality measurement for the secondary cell.

19. The method according to claim 16, further comprising
monitoring if the link failure is caused because a number of radio link control retransmissions by the apparatus exceeds a maximum number;
detecting at least one further secondary cell different from the secondary cell and the master cell, wherein the apparatus is additionally connected to the further secondary cell; wherein
the report is generated such that the report additionally comprises at least one of a result of a second power measurement and result of a second quality measurement for the further secondary cell if the link failure is caused because the maximum number of radio link control retransmissions and the apparatus is connected to the further secondary cell.

20. (canceled)

21. Method, comprising
monitoring if a report from a terminal is received, wherein the report reports on a link failure of a link of the terminal to a secondary cell;
informing, if the report is received, the secondary cell in a message on a presence of the report.

22. (canceled)

23. The method according to claim 21, further comprising providing the report in response to an inquiry received from the secondary cell.

24. The method according to claim 21, wherein the message comprises a request to the secondary cell.

25. The method according to claim 24, wherein the request requests the secondary cell to release the link from the secondary cell to the terminal.

26. Method, comprising
supervising if a message is received from a master base station, wherein the message comprises an indication of a presence of a report on a link failure of a link to a terminal;
adapting, if the message is received, a radio parameter based on the report.

27. The method according to claim 26, wherein the radio parameter comprises at least one of a time to trigger, an offset, and a mobility threshold.

28. (canceled)

29. The method according to claim 26, comprising:
inquiring the report from the master cell; and
receiving the report in response to the inquiry.

30. The method according to claim 26, wherein the message requests an apparatus performing the method to release the link to the terminal.

31. (canceled)

32. (canceled)

33. An apparatus comprising:
at least one processor; and
at least one memory including computer program code, the at least one memory and the computer program code configured, with the at least one processor, to cause the apparatus at least to:
detect an occurrence of a link failure of a link to a secondary cell, wherein, before the occurrence of the link failure, the apparatus is connected in dual connectivity to the secondary cell via the link and to a master cell different from the secondary cell; and
inform the master cell on the link failure by a report if the occurrence of the link failure is detected.

34. An apparatus comprising:
at least one processor; and
at least one memory including computer program code, the at least one memory and the computer program code configured, with the at least one processor, to cause the apparatus at least to:
monitor if a report from a terminal is received, wherein the report reports on a link failure of a link of the terminal to a secondary cell; and
inform, if the report is received, the secondary cell in a message on a presence of the report.

35. A computer program product comprising a non-transitory computer-readable storage medium bearing computer program code embodied therein for use with a computer, the computer program code comprising code for performing the method of claim 16.
